(19) United States
(12) Patent Application Publication
(10) Pub. No.: US 2025/0171073 A1
(43) Pub. Date: May 29, 2025

(54) STEERING SYSTEM HAVING A STEERING ROD

(71) Applicant: ZF Automotive Germany GmbH, Alfdorf (DE)

(72) Inventors: Ian Bläser, Bochum (DE); Metin Sönmez, Erkelenz (DE); Jacopo Francesco Zini, Sarezzo (BS) (IT); Fabrizio Peli, Gardone Val Trompia (BS) (IT)

(21) Appl. No.: 18/433,590

(22) Filed: Feb. 6, 2024

(30) Foreign Application Priority Data
Feb. 8, 2023 (DE) 102023200999.4

(51) Int. Cl. B62D 5/04

(52) U.S. Cl. CPC B62D 5/0403

(57) ABSTRACT

The disclosure relates to a steering system having a steering rod and a drive, wherein the drive is connected to the steering rod by a transmission for moving the latter, and having a sensor device for sensing a position of the steering rod. The sensor device is connected to the transmission by at least one reduction gear and/or the sensor device has at least one reduction gear for connecting to the transmission. In order to reduce the installation space requirement and/or for it to be possible to create a high transmission ratio, in the steering system, the reduction gear is in the form of a cycloidal gear.

### CROSS-REFERENCE TO RELATED APPLICATION

This application claims priority to German Priority Application No. 102023200999.4, filed Feb. 8, 2023, the disclosure of which is incorporated herein by reference in its entirety.

### TECHNICAL FIELD

The disclosure relates to a steering system having a steering rod and having a drive, wherein the drive is connected to the steering rod by a transmission for moving the steering rod, and having a sensor device for sensing a position of the steering rod, wherein the sensor device is connected to the transmission by at least one reduction gear and/or the sensor device has at least one reduction gear for connecting to the transmission.

### BACKGROUND

A steering system is known from DE 11 2020 002 949 T5. In that case, the reduction gear has a first gearwheel element and a second gearwheel element, which both cooperate with a toothing on an outer circumferential portion of an extension of a nut pulley of the transmission. In that case, the reduction ratio is dependent on the diameter of the gearwheel elements used. Depending on the input speed relative to a desired output speed, the gearwheel elements may have an undesirably large diameter and thus require a corresponding large installation space. Often, however, the installation space is limited or an installation space requirement that is as small as possible is desired as a matter of principle.

One issue that invites further development for a steering system of the type mentioned at the beginning, is that the installation space requirement is reduced and/or high transmission ratios are able to be realized. Accordingly, an alternative arrangement is needed.

### SUMMARY

In one exemplary arrangement, the disclosed steering system has a steering rod. For example, the steering rod is mounted movably in a steering box. The steering rod may extend outwardly out of the steering box at two mutually opposite ends. Due to the steering rod, wheels of a vehicle or motor vehicle can be steered. Furthermore, the steering system has a drive and a transmission. The drive is connected to the steering rod by the transmission. As a result, the steering rod is movable by the drive, for example in the longitudinal direction of a longitudinal center axis of the steering rod. In one exemplary arrangement, the steering rod is mounted so as to be rotationally fixed. The drive may be in the form of a motor, such as an electric motor. The steering system has a sensor device for sensing a position of the steering rod. To this end, the sensor device is connected to the transmission by at least one reduction gear. The sensor device senses, due to the reduction gear, at least one item of rotational information of the transmission, wherein, on the basis of the at least one item of rotational information, a current position of the steering rod is able to be determined. According to the disclosure, the reduction gear is in the form of a cycloidal gear.

It is advantageous that a cycloidal gear allows a compact construction, with the result that the installation space requirement is able to be reduced. Furthermore, a cycloidal gear allows a high reduction ratio with a comparatively high input speed relative to a desired, much lower output speed. In spite of a high reduction ratio, the steering system and/or the sensor device and/or the reduction gear can be realized in a compact and installation space-saving manner by the at least one cycloidal gear.

According to a further exemplary arrangement, the transmission has a spindle nut element that is mounted so as to be rotatable about a longitudinal center axis of the steering rod, wherein the spindle nut element is able to be driven and rotated, respectively, by the drive and transmission. For example, the spindle nut element is prevented from moving in the longitudinal direction of the steering rod. The spindle nut element is engaged with a spindle portion of the steering rod in order to move the steering rod in the longitudinal direction of the steering rod. In one exemplary arrangement, the steering rod is prevented from twisting about its longitudinal center axis. For example, an inner circumference of the spindle nut element cooperates with an outer circumference of the spindle portion. The transmission may be in the form of a gear drive or planetary transmission. In one exemplary arrangement, the transmission is in the form of a belt drive. When it is in the form of a belt drive, the spindle nut element may at the same time be in the form of a pulley.

Furthermore, in this exemplary arrangement, an eccentric drive element of the cycloidal gear for driving a cam disk of the cycloidal gear cooperates with the spindle nut element. Thus, the eccentric drive element drives the cam disk. in one exemplary arrangement, the eccentric drive element has an eccentric element arranged eccentrically with respect to an axis of rotation of the eccentric drive element, for example a disk element arranged eccentrically with respect to the axis of rotation or a receiving opening formed eccentrically with respect to the axis of rotation. Due to the eccentric element, the cam disk can be set in motion. The cam disk has, on its outer circumference, a predefined number of cam portions and/or cams. The cam disk may roll on disk portions and/or pins formed in a manner corresponding to the cam portions and/or cams. In one exemplary arrangement, the disk portions and/or pins are arranged in a ring-like manner with respect to one another. The disk portions and/or pins may be designed as constituents of a housing, in particular of a steering box or of a sensor housing. Alternatively, the disk portions and/or pins may be constituents of an, for example ring-like or annular, insert which is received or fastened in the housing. Thus, the cam disk can roll on the disk portions and/or pins. In one exemplary arrangement, the cam disk has a plurality of receptacles or apertures for cooperating with a rolling disk element. The rolling disk element may have a plurality of rollers or roller-like protrusions. In this case, in each case one roller or one roller-like protrusion of the rolling disk element can cooperate with one of the receptacles or apertures. The rolling disk element moves onward by one cam portion and/or cam per revolution of the eccentric drive element. As a result, a lower speed is realized on the part of the rolling disk element than on the part of the eccentric drive element.

According to one development, the eccentric drive element has a gearwheel portion, wherein an external toothing of the gearwheel portion is engaged with a circumferential toothing of the spindle nut element. For example, the longitudinal center axis of the steering rod and an axis of rotation of the eccentric drive element are arranged so as to be offset parallel to one another. In one exemplary arrangement, the spindle nut element has an extension that extends axially away from the spindle nut element. This extension may have the circumferential toothing of the spindle nut element.

According to an alternative configuration, the eccentric drive element has a fastening portion. The fastening portion is arranged for conjoint rotation on the spindle nut element and/or on a circumferential portion of the spindle nut element so as to rotate as one with the spindle nut element. For example, the longitudinal center axis of the steering rod and an axis of rotation of the eccentric drive element coincide with one another. The fastening portion of the eccentric drive element may be in the form of an aperture or through-opening. In one exemplary arrangement, the spindle nut element is connected to the eccentric drive element by way of a form fit so as to rotate as one with therewith. For example, an inner circumference of the fastening portion is designed so as to correspond in shape to an outer circumference of the spindle nut element. In one exemplary arrangement, the eccentric drive element passes around and/or surrounds the circumferential portion of the spindle nut element and is fixedly connected thereto. Alternatively, the spindle nut element may have at least one protrusion or a plurality of protrusions which each engage in a receptacle of corresponding shape of the eccentric drive element. According to a further alternative, the spindle nut element may have at least one recess or a plurality of recesses in each of which a protrusion of the eccentric drive element engages. The protrusions of the spindle nut element or of the eccentric drive element may extend parallel to a longitudinal axis of the steering rod.

The eccentric drive element may be in the form of a hollow shaft or of an annular disk. For example, the rolling disk element of the cycloidal gear is in the form of a hollow shaft or of an annular disk. In one exemplary arrangement, the longitudinal center axis of the steering rod, an axis of rotation of the eccentric drive element and an axis of rotation of the rolling disk element coincide with one another. For example, the rolling disk element is connected to a sensor rotor of the sensor device. The sensor rotor may have a ring-like design. Due to the rolling disk element, the sensor rotor is able to be driven and/or rotated. The outer circumference of the rolling disk element may be connected for conjoint rotation to an inner circumference of the sensor rotor.

If the rolling disk element of the cycloidal gear is in the form of an annular disk, the rolling disk element may have an external toothing. In this case, a first gearwheel of the sensor device and a second gearwheel of the sensor device may cooperate with the external toothing of the rolling disk element. For example, the first gearwheel and the second gearwheel of the sensor device are driven by the rolling disk element. In one exemplary arrangement, the position of the steering rod is determined or able to be determined by the sensor device and on the basis of a phase difference between the first gearwheel and the second gearwheel.

According to one exemplary development, the sensor device has a sensor housing, wherein the eccentric drive element, the cam disk and the rolling disk element are arranged within the sensor housing. The at least one cycloidal gear may be arranged within the sensor housing. Because the cycloidal gear is arranged within the sensor housing, it is well protected against external influences. For example, the sensor housing is arranged within a steering box. In one exemplary arrangement, the steering box is guided without contact through central openings in the eccentric drive element, in the cam disk and/or in the rolling disk element. For example, the steering rod is guided without contact through openings in the sensor housing.

According to a further exemplary arrangement, the sensor device is connected to the transmission, such as to the spindle nut element of the transmission, by a first cycloidal gear and of a second cycloidal gear. In this case, the two cycloidal gears can be arranged parallel to one another. The position of the steering rod is determined or able to be determined by the sensor device and on the basis of a phase difference between the first cycloidal gear and the second cycloidal gear. The first cycloidal gear and the second cycloidal gear may be constituents of the sensor device itself. For example, it is possible to dispense with a sensor rotor when two cycloidal gears are used. The installation space requirement is able to be reduced even further.

In one exemplary arrangement, the first cycloidal gear has a first eccentric drive element and the second cycloidal gear has a second eccentric drive element. In this case, the two eccentric drive elements may each have a gearwheel portion with an external toothing, wherein the external toothings are each engaged with a circumferential toothing of the spindle nut element of the transmission. For example, the two eccentric drive elements are in the form of gearwheels.

In one exemplary arrangement, the first eccentric drive element has a larger outside diameter than the second eccentric drive element. For example, the external toothing of the first eccentric drive element has at least one tooth more than the external toothing of the second eccentric drive element. The cam disks of the first cycloidal gear and of the second cycloidal gear may be in the form of common parts. The position of the steering rod is determined or able to be determined by the sensor device and on the basis of a phase difference between the first eccentric drive element and the second eccentric drive element.

According to an alternative configuration, the first cycloidal gear has a first cam disk and the second cycloidal gear has a second cam disk, wherein the first cam disk has a larger outside diameter than the second cam disk. For example, an outer circumference of the first cam disk has at least one cam portion and/or at least one cam more than an outer circumference of the second cam disk. The eccentric drive elements of the first cycloidal gear and of the second cycloidal gear are in the form of common parts. The position of the steering rod is determined or able to be determined by the sensor device and on the basis of a phase difference between the first cam disk and the second cam disk.

Advantageously, the steering system according to the disclosure is in the form of steer-by-wire steering for a vehicle, such as a motor vehicle. Steer-by-wire steering is a type of electrical steering which steers a vehicle using electrical energy without there being a mechanical connection, for example a steering column, between a steering wheel and front-wheel steering. In addition or as an alternative to the use of steer-by-wire steering for front-wheel steering, steer-by-wire steering can be used for rear-wheel steering.

In steer-by-wire steering, the operation of the steering wheel by the drive is converted into an electrical signal. Such steer-by-wire steering without a mechanical connection can reduce injuries to the driver by a mechanical part in the event of an accident. Since the mechanical connection and/or hydraulic parts can be dispensed with, the weight of a vehicle can be reduced on account of the smaller number of parts. Simplifications such as greatly reduced assembly effort can be achieved. Furthermore, energy consumption during a steering operation can be reduced and thus the overall energy efficiency of the vehicle improved.

### BRIEF DESCRIPTION OF DRAWINGS

The disclosure is explained in more detail in the following text with reference to the figures. Here, identical reference signs refer to identical, similar or functionally identical components or elements. In the figures:

FIG. 1 shows a sectional side view of a steering system according to the disclosure,

FIG. 2 shows a schematic illustration of a cycloidal gear,

FIG. 3 shows a detail of a sectional side view of a first steering system according to the disclosure,

FIG. 4 shows a detail of a sectional side view of a second steering system according to the disclosure,

FIG. 5 shows a schematic cross section of the cycloidal gear for the second steering system according to the disclosure according to FIG. 4,

FIG. 6 shows a detail of a perspective exploded illustration of a third steering system according to the disclosure,

FIG. 7 shows a detail of a perspective exploded illustration of a fourth steering system according to the disclosure,

FIG. 8 shows a partially transparent detail of a perspective side view of a further steering system according to the disclosure,

FIG. 9 shows a detail of a perspective view of a first partially assembled portion for forming the further steering system according to FIG. 8,

FIG. 10 shows a detail of a perspective view of a further partially assembled portion for forming the further steering system according to FIG. 8,

FIG. 11 shows a perspective exploded illustration of a sensor device for forming the further steering system according to FIG. 8,

FIG. 12 shows a first perspective side view of constituents for forming the sensor device according to FIG. 11, and

FIG. 13 shows a further perspective side view of constituents for forming the sensor device according to FIG. 11.

### DETAILED DESCRIPTION

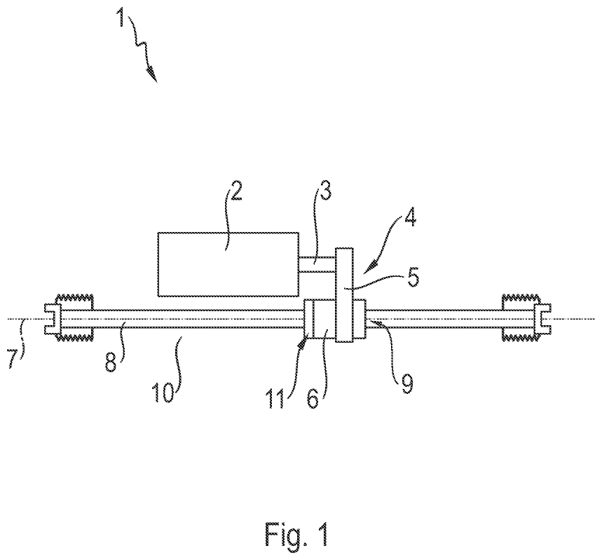

FIG. 1 shows a sectional side view of a steering system 1 according to the disclosure. In this exemplary arrangement, the steering system 1 is in the form of steer-by-wire steering. The steering system 1 has a drive 2, which in this case is in the form of an electric motor. The drive 2 is connected to a transmission 4 by a driveshaft 3. The transmission 4 is realized as a belt drive in this exemplary arrangement. Accordingly, the transmission 4 in this case has a belt 5, although it is understood that other transmission arrangements are contemplated.

The transmission 4 has a spindle nut element 6, which, according to this example, is able to be driven by the belt 5. The spindle nut element 6 is in this case mounted so as to be rotatable about a longitudinal center axis 7 of a steering rod 8 by the drive 2. To this end, the spindle nut element 6 is engaged with a spindle portion 9 of the steering rod 8. Specifically, an inner circumference of the spindle nut element 6 cooperates with an outer circumference of the spindle portion 9. The spindle nut element 6 is prevented from moving in the longitudinal direction of the steering rod 8. At the same time, the steering rod 8 is prevented from twisting about its longitudinal center axis 7. Thus, the steering rod 8 can be moved in the longitudinal direction of the longitudinal center axis 7 on account of a rotation of the spindle nut element 6.

The steering rod 8 extends outwardly out of a steering box 10 at two mutually opposite ends. Due to the steering rod 8, wheels of a vehicle or motor vehicle that are not illustrated in more detail here can be steered.

A sensor device 11 is arranged within the steering housing 10 and in a manner assigned to the spindle nut element 6. The sensor device 11 is only schematically indicated here. Due to the sensor device 11, a current position of the steering rod 8 is able to be determined or sensed.

The sensor device 11 is connected to the transmission 4, specifically in this case to the spindle nut element 6, by a cycloidal gear that is not illustrated in more detail here. Various exemplary arrangements are explained in more detail with reference to the following figures.

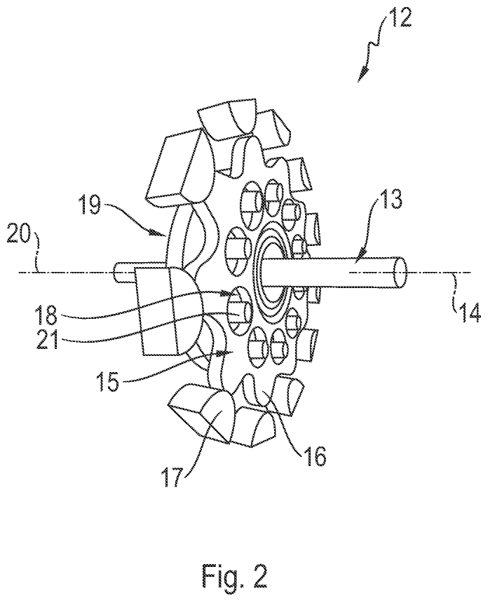

First of all, FIG. 2 shows a schematic illustration of a cycloidal gear 12 in order to explain the basic structure and manner of operation of a cycloidal gear independently of the present disclosure.

The cycloidal gear 12 has an eccentric drive element 13. The eccentric drive element 13 is able to be rotated about an axis of rotation 14. By operation of the eccentric drive element 13, a cam disk 15 of the cycloidal gear 12 is able to be driven.

The cam disk 15 has, on its outer circumference, a predefined number of cam portions or so-called cams 16. For the sake of greater clarity, not all of the cams 16 have been provided with a reference sign.

Furthermore, the cycloidal gear 12 has a plurality of disk portions 17 designed to correspond to the cams 16. The disk portions 17 may also be referred to as or be in the form of pins. For the sake of greater clarity, not all of the disk portions 17 have been provided with a reference sign. The disk portions 17 are arranged in a ring-like manner with respect to one another. Furthermore, the disk portions 17 may be designed as constituents of a housing, for example of the steering box 10 or of a sensor housing.

The cam disk 15 can roll on the disk portions 17 by the cams 16.

The cam disk 15 has a plurality of apertures 18 for cooperating with a rolling disk element 19. For the sake of greater clarity, not all of the apertures 18 have been provided with a reference sign. The rolling disk element 19 is able to be rotated about an axis of rotation 20. The axis of rotation 20 of the rolling disk element 19 and the axis of rotation 14 of the eccentric drive element 13 coincide with one another.

Furthermore, the rolling disk element 19 has a plurality of roller-like protrusions 21. The protrusions 21 may be referred to as or be in the form of rollers. For the sake of greater clarity, not all of the protrusions 21 have been provided with a reference sign. In each case one roller-like protrusion 21 of the rolling disk element 19 cooperates with one of the apertures 18. To this end, in each case one protrusion 21 extends into an aperture 18, wherein an outer circumference of the protrusion 21 bears against an inner circumference of the aperture 18. In this case, the hollow-cylindrical inside diameter of the aperture 18 is larger than the cylindrical outside diameter of the protrusion 21. The rolling disk element 19 moves onward by one cam 16 per revolution of the eccentric drive element 13. As a result, a lower speed is realized on the part of the rolling disk element 19 than on the part of the eccentric drive element 13.

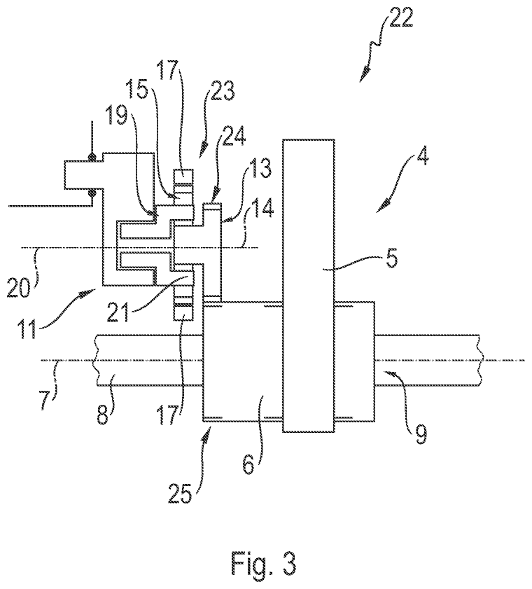

FIG. 3 shows a detail of a sectional side view of a first steering system 22 according to the disclosure. In principle, the first steering system 22 corresponds to the steering system 1 according to FIG. 1. The first steering system 22 has a cycloidal gear 23 which, in terms of its structure and manner of operation, corresponds in principle to the cycloidal gear according to FIG. 2. Identical features bear the same reference signs as before. In this respect, to avoid repetitions, reference is made to the preceding description.

The cycloidal gear 23 connects the transmission 4, more specifically the spindle nut element 6, to the sensor device 11. According to this exemplary arrangement, the eccentric drive element 13 has a gearwheel portion 24. The gearwheel portion 24, more specifically an external toothing of the gearwheel portion 24, is engaged with a circumferential toothing 25 of the spindle nut element 6. The circumferential toothing 25 is formed on a circumferential portion of the spindle nut element 6 or in the region of an axial extension of the spindle nut element 6.

The longitudinal center axis 7 of the steering rod 8 and the axis of rotation 14 of the eccentric drive element 13 are arranged so as to be offset parallel to one another in this example. The disk elements 17 of the cycloidal gear 23 are in the form of constituents of a sensor housing (not illustrated in more detail here) according to this exemplary arrangement.

Upon rotation of the spindle nut element 6, the eccentric drive element 13 is set in rotation at the same time, with the result that, ultimately, the rolling disk element 19 is set into rotational motion about the axis of rotation 20. In this exemplary arrangement, the rolling disk element 19 drives a sensor rotor (not illustrated in more detail here) of the sensor device 11.

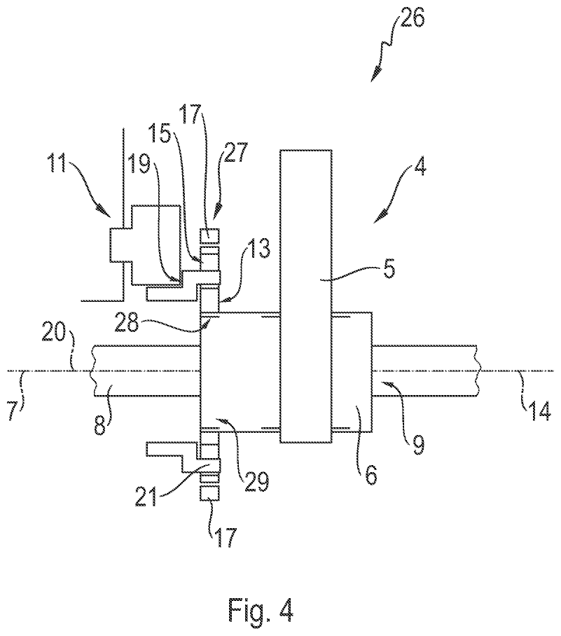

FIG. 4 shows a detail of a sectional side view of a second steering system 26 according to the disclosure. In principle, the second steering system 26 corresponds to the steering system 1 according to FIG. 1. The second steering system 26 has a cycloidal gear 27 which, in terms of its structure and manner of operation, corresponds in principle to the cycloidal gear according to FIG. 2. Identical features bear the same reference signs as before. In this respect, to avoid repetitions, reference is made to the preceding description.

The cycloidal gear 27 connects the transmission 4, more specifically the spindle nut element 6, to the sensor device 11. According to this exemplary arrangement, the eccentric drive element 13, in contrast to the previous arrangements, has a fastening portion 28. The fastening portion 28 is in the form of a through-opening in this example of the eccentric drive element 13. The fastening portion 28 is arranged for conjoint rotation on a circumferential portion 29 of the spindle nut element 6 and so as to rotate as one with the spindle nut element 6. To this end, an inner circumference of the fastening portion 28 is designed so as to correspond in shape to an outer circumference of the spindle nut element 6, more specifically of the circumferential portion 29. Thus, the eccentric drive element 13 passes around or surrounds the circumferential portion 29 of the spindle nut element 6 and is fixed connected thereto.

Furthermore, in this exemplary arrangement, the rolling disk element 19 of the cycloidal gear 27 is in the form of a hollow shaft. As a result, the longitudinal center axis 7 of the steering rod 8, the axis of rotation 14 of the eccentric drive element 13 and the axis of rotation 20 of the rolling disk element 19 coincide with one another.

The disk elements 17 of the cycloidal gear 27 are in the form of constituents of the steering box 10 (not illustrated in more detail here) according to this exemplary arrangement.

Upon rotation of the spindle nut element 6, the eccentric drive element 13 is set in rotation at the same time, with the result that, ultimately, the rolling disk element 19 is set in rotational motion about the axis of rotation 20. In this exemplary arrangement, the rolling disk element 19 drives a sensor rotor (not illustrated in more detail here) of the sensor device 11.

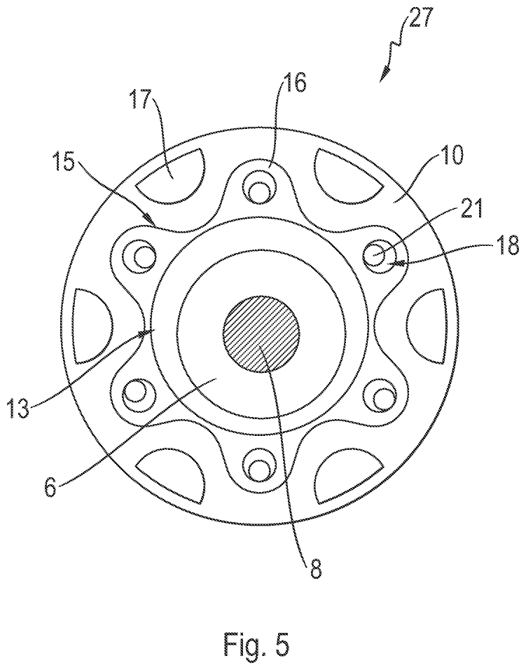

FIG. 5 shows a schematic cross section of the cycloidal gear 27 for the second steering system 26 according to the disclosure according to FIG. 4. It is clearly apparent that the disk elements 17 are in the form of constituents of the steering box 10. Furthermore, as is also shown in FIG. 4, the longitudinal center axis 7 of the steering rod 3, the axis of rotation 14 of the eccentric drive element 13 and the axis of rotation 20 of the rolling disk element 19 coincide with one another. With regard to the rolling disk element 19, only the roller-like protrusions 21 are illustrated here.

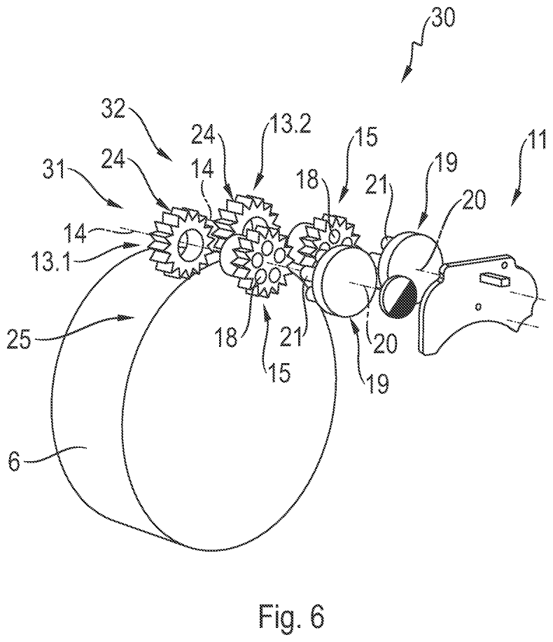

FIG. 6 shows a detail of a perspective exploded illustration of a third steering system 30 according to the disclosure. Only the spindle nut element 6 and a first cycloidal gear 31 and a second cycloidal gear 32 are schematically indicated here. In principle, the third steering system 30 corresponds to the steering system 1 according to FIG. 1. In terms of their structure and manner of operation, the two cycloidal gears 31, 32 correspond in principle to the cycloidal gear according to FIG. 2. Identical features bear the same reference signs as before. In this respect, to avoid repetitions, reference is made to the preceding description. The respective disk portions 17 are not illustrated in more detail here.

The sensor device 11 is connected to the transmission 4 and to the spindle nut element 6, respectively, by the first cycloidal gear 31 and the second cycloidal gear 32. To this end, the two cycloidal gears 31, 32 are arranged parallel to one another. In this exemplary arrangement, the first cycloidal gear 31 and the second cycloidal gear 32 are in the form of constituents of the sensor device 11 itself. In addition, in this exemplary arrangement, it is possible to dispense with a sensor rotor in use.

The first cycloidal gear 31 has a first eccentric drive element 13.1 and the second cycloidal gear 32 has a second eccentric drive element 13.2. The two eccentric drive elements 13.1 and 13.2 each have a gearwheel portion 24 with an external toothing. In this exemplary arrangement, the two eccentric drive elements 13.1 and 13.2 are in the form of gearwheels.

The gearwheel portions 24, more specifically the external toothings of the two eccentric drive elements 13.1 and 13.2, are each engaged with a circumferential toothing 25 (not illustrated in more detail here) of the spindle nut element 6. The circumferential toothing 25 is formed on a circumferential portion of the spindle nut element 6 or in the region of an axial extension of the spindle nut element 6.

In a similar way to the arrangement according to FIG. 3, the longitudinal center axis 7 of the steering rod 8 and the axes of rotation 14 of the eccentric drive elements 13.1 and 13.2 are oriented so as to be offset parallel to one another in this example.

Upon rotation of the spindle nut element 6, the eccentric drive elements 13.1 and 13.2 are set in rotation at the same time, with the result that, ultimately, the respective rolling disk elements 19 are set into rotational motion about their axis of rotation 20.

The position of the steering rod 8 is determined or able to be determined by the sensor device 11 and on the basis of a phase difference between the first cycloidal gear 31 and the second cycloidal gear 32.

To this end, in this exemplary arrangement, the first eccentric drive element 13.1 has a larger outside diameter than the second eccentric drive element 13.2. As a result, in this example, the external toothing of the first eccentric drive element 13.1 has one tooth more than the external toothing of the second eccentric drive element 13.2. By contrast, the cam disks 15 of the first cycloidal gear 31 and of the second cycloidal gear 32 are in the form of common parts. The cams 16 of the respective cam disks are only schematically indicated here.

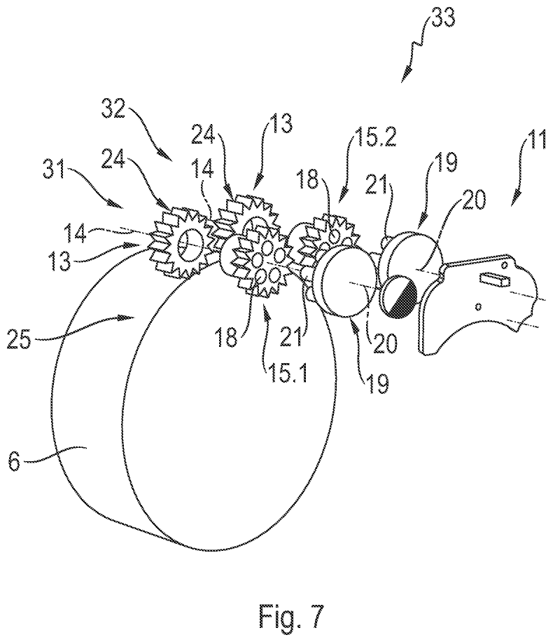

FIG. 7 shows a detail of a perspective exploded illustration of a fourth steering system 33 according to the disclosure. The fourth steering system 33 corresponds largely to the third steering system 30 according to FIG. 6. In this respect, to avoid repetitions, reference is made to the preceding description in relation to FIG. 6.

Unlike the third steering system 30, in the case of the steering system 33 illustrated here, the eccentric drive elements 13 of the first cycloidal gear 31 and of the second cycloidal gear 32 are in the form of common parts. Instead, the cam disk 15.1 of the first cycloidal gear 31 and the cam disk 15.2 of the second cycloidal gear 32 have different designs. In this exemplary embodiment, the first cam disk 15.1 has a larger outside diameter than the second cam disk 15.2. As a result, in this example, an outer circumference of the first cam disk 15.1 has one cam 16 more than an outer circumference of the second cam disk 15.2 On the basis of a phase difference between the first cam disk 15.1 and the second cam disk 15.2, the position of the steering rod 8 is able to be determined by the sensor device 11.

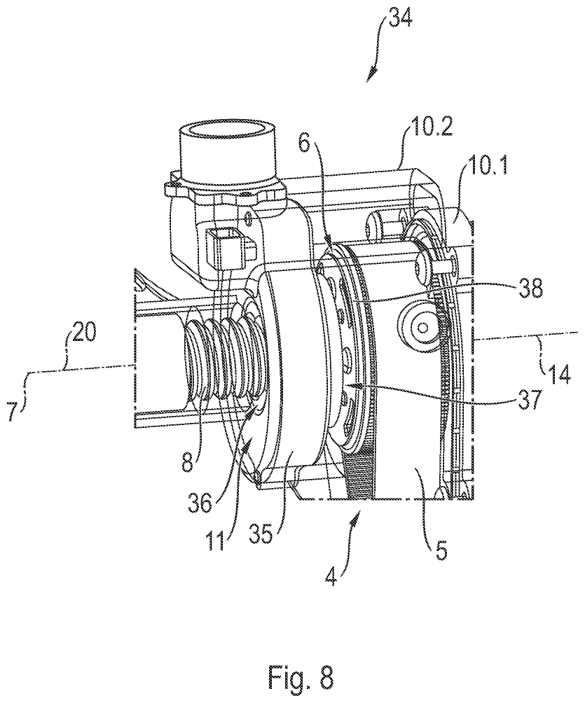

FIG. 8 shows a partially transparent detail of a perspective side view of a further steering system 34 according to the invention. According to this exemplary arrangement, the sensor device 11 has a sensor housing 35. The second housing has two mutually opposite openings 36, 37, through which the steering rod 8 extends without contact. The reduction gear in the form of a cycloidal gear is arranged within the sensor housing 35 in this exemplary arrangement, as is explained in yet more detail with reference to the following figures. Thus, in this case, the sensor device 11 has the reduction gear for connecting to the transmission 4.

In this arrangement, the transmission 4 is realized as a belt drive. Accordingly, the transmission 4 in this case has a belt 5. As was already the case in the preceding exemplary arrangements, the transmission 4 shown here also has a spindle nut element 6. According to this example, the spindle nut element 6 is able to be driven by the belt 5. Accordingly, according to this exemplary arrangement, the spindle nut element 6 is in the form of a belt pulley which has a flanged wheel 38. The spindle nut element 6 and thus also the flanged wheel 38 are in this case mounted so as to be rotatable about the longitudinal center axis 7 of the steering rod 8 by a drive 2 that is not illustrated in more detail here. To this end, the spindle nut element 6 is engaged with a spindle portion 9 (not discernible in more detail) of the steering rod 8. The sensor device 11 and the sensor housing 36 are arranged next to the flanged wheel 38. In other words, the flanged wheel 38 and one side of the sensor housing 36 are positioned so as to face one another.

The longitudinal center axis 7 of the steering rod 8, the axis of rotation 14 of the eccentric drive element 13 (not discernible in more detail here) and the axis of rotation 20 of the rolling disk element 19 coincide with one another in this exemplary arrangement.

Furthermore, in this exemplary arrangement, the steering box 10 is assembled from a first steering box part 10.1 and a further steering box part 10.2. In this case, the sensor housing 35 is arranged within the steering box 10, more specifically within an assembled region of the two steering box parts 10.1 and 10.2.

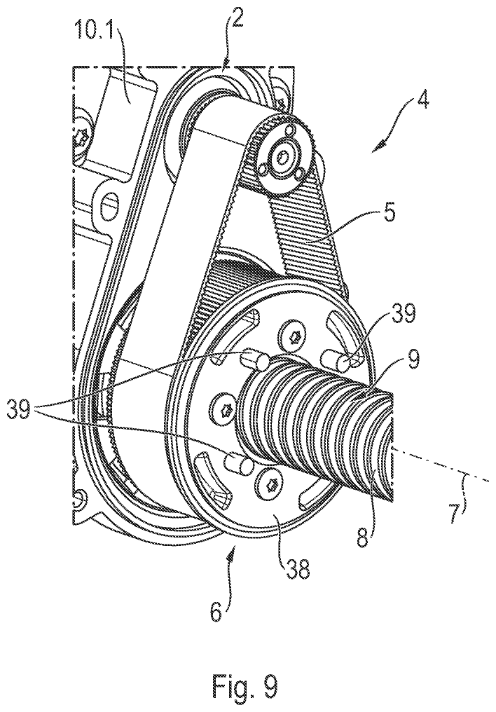

FIG. 9 shows a detail of a perspective view of a first partially assembled portion for forming the further steering system 34 according to FIG. 8. What is apparent is the first steering box part 10.1 with the transmission 4, via which the partially illustrated drive 2 is connected to the spindle portion 9 of the steering rod 8 by the belt 5 and the spindle nut element 6.

The spindle nut element 6, or more specifically, in this exemplary arrangement, the flanged wheel 38, has a plurality of protrusions 39. The protrusions 39 are in this case for example in the form of pins or pegs and extend in the longitudinal direction, or parallel to the longitudinal center axis 7 of the steering rod 8. With regard to the assembled state according to FIG. 8, the protrusions 38 extend in the direction of the sensor device 11.

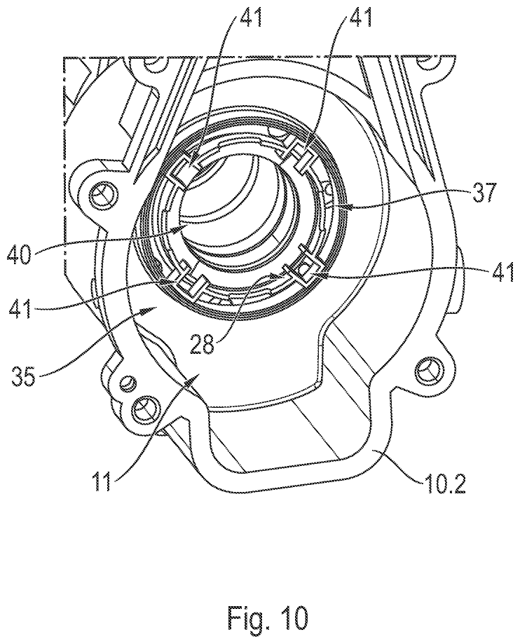

FIG. 10 shows a detail of a perspective view of a further partially assembled portion for forming the further steering apparatus 34 according to FIG. 8. What is apparent is the further steering box part 10.2 having the sensor device 11 and the sensor housing 35. The sensor housing 35 is received within the steering box part 10.2, or has been inserted into the steering box part 10.2, with a form fit. In this case, the sensor housing 35 and the steering box part 10.2 are designed so as to correspond in shape to one another such that the sensor housing 35 is held at least so as to be rotationally fixed with regard to the longitudinal center axis 7 (not illustrated in more detail here) of the steering rod 8.

Through the opening 37 in the sensor housing 35, the eccentric drive element 13 is visible. In this exemplary arrangement, the eccentric drive element 13 has its own opening 40, through which, in the assembled state according to FIG. 8, the steering rod 8 extends without contact. The eccentric drive element 13 has a fastening portion 28 for connecting for conjoint rotation to the spindle nut element 6 according to FIG. 9. According to this exemplary arrangement, the eccentric drive element 13, more specifically the fastening portion 28, has a plurality of receptacles 41. These receptacles 41 serve to cooperate with the protrusions 39 according to FIG. 9.

In the assembled state according to FIG. 8, the protrusions 39 extend right into the receptacles 41. Thus, the protrusions 39 and the receptacles 41 cooperate with a form fit. In this way, the spindle nut element 6 is connected to the eccentric drive element 13 by way of a form fit so as to rotate as one therewith.

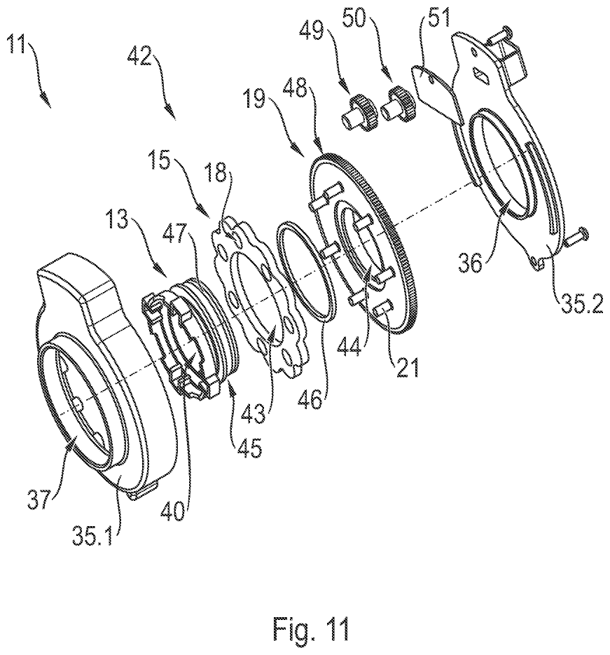

FIG. 11 shows a perspective exploded illustration of the sensor device 11 for forming the further steering system 34 according to FIG. 8. In this exemplary arrangement, the sensor housing 35 is formed in two parts from a first sensor housing part 35.1 and a second sensor housing part 35.2. Also apparent are the constituents for forming the cycloidal gear 42 that acts as a reduction gear.

In the assembled state according to FIG. 8 or 10, the eccentric drive element 13, the cam disk 15 and the rolling disk element 19 are arranged within the sensor housing 35. In this case, the steering rod S has been guided without contact through central openings 37, 38, 40, 43, 44 in the sensor housing 35, in the eccentric drive element 13, in the cam disk 15 and in the rolling disk element 19.

In this exemplary arrangement, the eccentric drive element 13 is in the form of a hollow shaft and has a hollow shaft-like portion 45 to which the annular disk-like cam disk 15 has been fixed. In this exemplary arrangement, for additionally securing the cam disk 15 to the eccentric drive element 13, a retaining ring 46 is provided. In the assembled state, the retaining ring 46 is fixed in a retaining groove 47 in the hollow shaft-like portion 45 of the eccentric drive element 13.

The rolling disk element 19 of the cycloidal gear 42 is in the form of an annular disk in this exemplary arrangement. The rolling disk element 19 has the protrusions 21 for cooperating with the apertures 18 in the cam disk 15. In this regard, reference is made to the preceding description.

The rolling disk element 19 of the cycloidal gear 42 has an external toothing 48. This external toothing 48 serves to cooperate with a first gearwheel 49 and a second gearwheel 50.

In the assembled state according to FIG. 8, the position of the steering rod 8 is able to be determined by the sensor device 11 and on the basis of a phase difference between the first gearwheel 49 and the second gearwheel 50. To this end, in this exemplary arrangement, the first gearwheel 49 has a smaller outside diameter than the second gearwheel 50. In this example, the first gearwheel 49 has fewer teeth than the second gearwheel 50. To sense the phase difference, use is made of a sensor element 51.

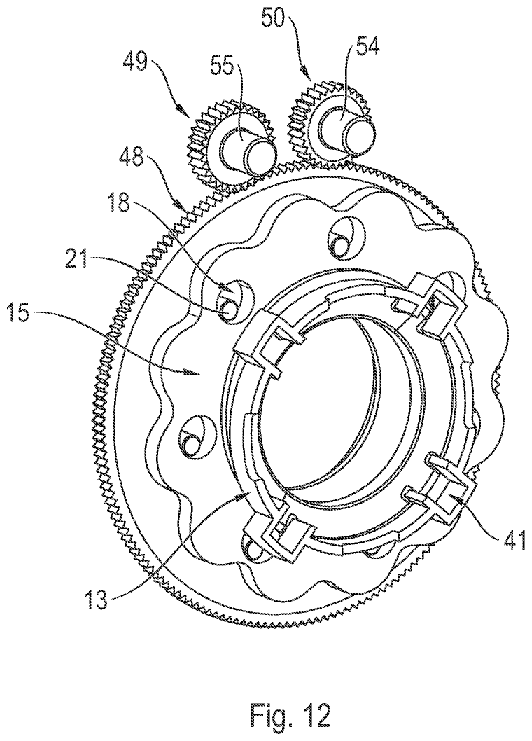

FIG. 12 shows a first perspective side view of constituents for forming the sensor device 11 according to FIG. 11. What is apparent is the cam disk 15 fixed to the eccentric drive element 13, and the rolling disk element 19 that cooperates with the cam disk 15 by the apertures 18 and the protrusions 21. In addition, the gearwheels 49, 50 engaged with the external toothing 48 of the rolling disk element 19 are illustrated.

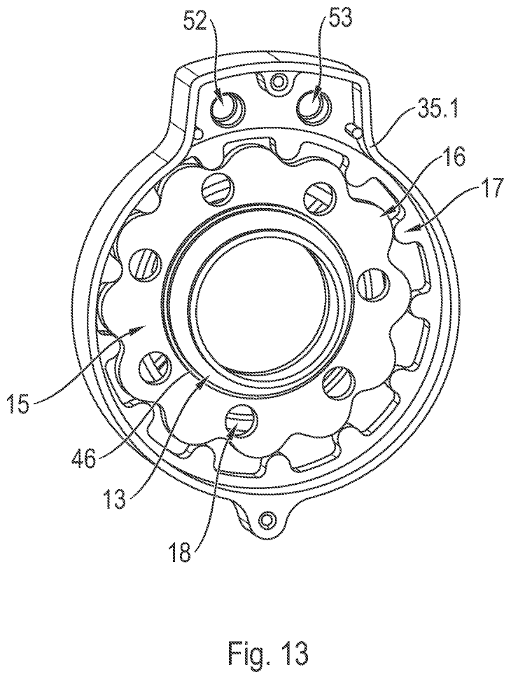

FIG. 13 shows a further perspective side view of constituents for forming the sensor device 11 according to FIG. 11. The cam disk 15 is fixed to the eccentric drive element 13 and additionally secured by the retaining ring 46.

In this exemplary arrangement, the sensor housing part 35.1 has a plurality of disk portions 17. The disk portions 17 are thus in the form of one-piece constituents of the sensor housing 35, or of the sensor housing part 35.1. The disk portions 17 cooperate with the cams 16 of the cam disk in a manner known per se in order to realize the function of the cycloidal gear 42 according to FIG. 11. For the sake of greater clarity, not all of the cam disks 17 and cams 16 have been provided with a reference sign.

Furthermore, in this exemplary arrangement, two axle guiding receptacles 52, 53 are formed in the sensor housing part 35.1. The axle guiding receptacles 52, 53 serve for mounting and rotatably receiving an axle portion 54 or 55, respectively, of the gearwheel 49 or 50, respectively, according to FIG. 12.

1. A steering system comprising: a steering rod and a drive, wherein the drive is connected to the steering rod by a transmission for moving the steering rod, and having a sensor device for sensing a position of the steering rod, wherein the sensor device is connected to the transmission by at least one reduction gear and/or the sensor device has at least one reduction gear for connecting to the transmission, wherein the reduction gear is in the form of a cycloidal gear.

2. The steering system as claimed in claim 1, wherein the transmission has a spindle nut element, wherein the spindle nut element is mounted so as to be rotatable about a longitudinal center axis of the steering rod by the drive and the spindle nut element is engaged with a spindle portion of the steering rod in order to move the steering rod, and an eccentric drive element of the cycloidal gear for driving a cam disk of the cycloidal gear cooperates with the spindle nut element.

3. The steering system as claimed in claim 2, wherein the eccentric drive element has a gearwheel portion, wherein an external toothing of the gearwheel portion is engaged with a circumferential toothing of the spindle nut element.

4. The steering system as claimed in claim 2, wherein the eccentric drive element has a fastening portion, wherein the fastening portion is arranged for conjoint rotation on the spindle nut element and/or on a circumferential portion of the spindle nut element so as to rotate as one with the spindle nut element.

5. The steering system as claimed in claim 4, wherein the eccentric drive element and/or a rolling disk element of the cycloidal gear is or are in the form of a hollow shaft or annular disk.

6. The steering system as claimed in claim 5, wherein the rolling disk element of the cycloidal gear is in the form of an annular disk, wherein the rolling disk element has an external toothing, and a first gearwheel and a second gearwheel cooperate with the external toothing of the rolling disk element.

7. The steering system as claimed in claim 4, wherein the sensor device has a sensor housing, wherein the eccentric drive element, the cam disk and the rolling disk element are arranged within the sensor housing.

8. The steering system as claimed in claim 1, wherein the sensor device is connected to the transmission by a first cycloidal gear and of a second cycloidal gear, and/or wherein the sensor device has a first cycloidal gear and a second cycloidal gear for connecting to the transmission.

9. The steering system as claimed in claim 8, wherein the first cycloidal gear has a first eccentric drive element and the second cycloidal gear has a second eccentric drive element, wherein the two eccentric drive elements each have a gearwheel portion with an external toothing, and the external toothings are each engaged with a circumferential toothing of a spindle nut element of the transmission.

10. The steering system as claimed in claim 9, wherein the external toothing of the first eccentric drive element has at least one tooth more than the external toothing of the second eccentric drive element, and the cam disks of the first cycloidal gear and of the second cycloidal gear are in the form of common parts.

11. The steering system as claimed in claim 9, wherein the first cycloidal gear has a first cam disk and the second cycloidal gear has a second cam disk, wherein the first cam disk has a larger outside diameter than the second cam disk.

12. The steering system as claimed in claim 1, which is in the form of steer-by-wire steering for a vehicle.

13. The steering system of claim 3, wherein the longitudinal center axis of the steering rod and an axis of rotation of the eccentric drive element are arranged so as to be offset parallel to one another.

14. The steering system of claim 4, wherein the spindle nut element is connected to the eccentric drive element by way of a form fit so as to rotate as one therewith.

15. The steering system of claim 14 wherein the longitudinal center axis of the steering rod and an axis of rotation of the eccentric drive element coincide with one another.

16. The steering system of claim 5, wherein the rolling disk element is connected to a sensor rotor of the sensor device, and the outer circumference of the rolling disk element is connected for conjoint rotation to an inner circumference of the sensor rotor.

17. The steering system of claim 6, wherein the position of the steering rod is determined or able to be determined by the sensor device and on the basis of a phase difference between the first gearwheel and the second gearwheel.

18. The steering system of claim 7, wherein the sensor housing is arranged within a steering box and the steering rod is guided without contact through central openings in the sensor housing, in the eccentric drive element, in the cam disk and/or in the rolling disk element.

19. The steering system of claim 8, wherein the position of the steering rod is determined or able to be determined by the sensor device and on the basis of a phase difference between the first cycloidal gear and the second cycloidal gear.

20. The steering system of claim 11, wherein an external circumference of the first cam disk has at least one cam portion and/or at least one cam more than an external circumference of the second cam disk, and the eccentric drive elements of the first cycloidal gear and of the second cycloidal gear are in the form of common parts.
